(19) United States
(12) Patent Application Publication
(10) Pub. No.: US 2024/0222801 A1
(43) Pub. Date: Jul. 4, 2024

(54) BATTERY COMPONENTS AND METHOD OF WELDING THE SAME

(71) Applicant: JAGUAR LAND ROVER LIMITED, Whitley, Coventry, Warwickshire (GB)

(72) Inventors: Mohamed AL-BADANI, Coventry, Warwickshire (GB); Paul HANEY, Coventry, Warwickshire (GB)

(21) Appl. No.: 18/280,463

(22) PCT Filed: Mar. 2, 2022
(86) PCT No.: PCT/EP2022/055305

§ 371 Date: Sep. 5, 2023

(30) Foreign Application Priority Data
Mar. 3, 2021 (GB) 2102994.7

(51) Int. Cl. H01M 50/516; B23K 26/22; H01M 50/505; B23K 101/38

(52) U.S. Cl. CPC H01M 50/516; B23K 26/22; H01M 50/505; B23K 2101/38

(57) ABSTRACT

The present disclosure relates to busbar assemblies (206) and battery modules (200). A method comprises welding a lattice portion (302) and a terminal collection plate (304) together by welding a first weld point (402), welding at a second weld point (404), and welding at a third point (406) between the first and the second weld points.

### TECHNICAL FIELD

The present invention relates generally to components for batteries. In particular, but not exclusively, the invention relates to components for vehicle traction batteries. Aspects relate to methods of manufacture of a battery module, methods of laser welding a lattice portion of a busbar assembly, for example to form a battery module, battery modules, busbar assemblies, battery packs, control systems and vehicles.

### BACKGROUND

There has recently been increased interest in providing battery-powered vehicles, which has led to developments in vehicle batteries, in particular vehicle traction battery technology. It is generally desirable for vehicle batteries to provide high energy capacity and peak current output, whilst minimising the size and weight of the battery module and thus the vehicle.

Vehicle traction batteries often comprise one or more modules each containing a plurality of cells. It is generally desirable to package the cells into a battery module as densely as can safely be achieved, so as to maximise the energy and current capacity that can be provided within a given packaging volume.

Electrical connections between cells are typically provided by a busbar assembly. It is generally desirable to reduce the size and weight of the busbar assembly, whilst also reducing the electrical resistance introduced by the busbar assembly.

It is also desirable to provide manufacturing processes that are highly repeatable and that avoid faulty electrical connections. A single battery module will typically comprise a large number of electrical connections between cells and the busbar assembly, and any faulty connections may lead to the entire module malfunctioning, potentially requiring an entire module failing quality control and having to be reworked where possible or otherwise scrapped.

It is an object of examples disclosed herein to at least mitigate one or more of the problems of the prior art.

### SUMMARY

According to an aspect, there is provided a method of laser welding a lattice portion of a busbar assembly, the lattice portion comprising copper, to a terminal collection plate of the busbar assembly, the terminal collection plate comprising aluminium,
the method comprising controlling a laser welding system to perform a welding process to weld the lattice portion and the terminal collection plate together at a plurality of weld points by:
welding the lattice portion and the terminal collection plate together at a first weld point;
welding the lattice portion and the terminal collection plate together at a second weld point; and
welding the lattice portion and the terminal collection plate together at a third point in a region formed between the first and the second weld point.

In some examples, the lattice portion of the busbar assembly need not necessarily comprise copper. In some examples, the terminal collection plate of the busbar assembly need not necessarily comprise aluminium.

Thus, between the first and a subsequent weld point, the busbar assembly at the subsequent weld point may be at a lower temperature than the busbar at the first position (or another prior welded position) due to the welding of the first (or prior) point causing localised heating of the busbar at the first (or prior) position. Welding the lattice portion and the terminal collection plate together at a first weld point may cause a temperature gradient having a localised high temperature region at the first weld point and a low temperature region elsewhere. A subsequent weld point may then be located at a low temperature region of the weld surface, which is spatially distanced from the localised high temperature region. It is desirable to avoid localised heating which can warp the shape of the busbar away from an intended shape (for example, buckling or bending a busbar assembly which is it desirable to have in a flat plane), in order to allow for improved contact and welding of terminal connection tabs of the busbar assembly to respective terminals of the electrical cells in the cell array.

The lattice portion in some examples may be a metallic sheet comprising a plurality of tabs to be welded to respective terminals of electrical cells of a battery assembly, to thereby electrically connect the busbar assembly to each of the electrical cells in a cell array of a battery assembly. The term “portion” may be understood to relate to a part, or component, of the busbar assembly, such as the lattice portion. The term “region” may be taken to mean a place of location/area of the busbar assembly, such as an edge region or a peripheral region.

The weld points may be understood to be locations on a weld surface, which is a surface between the lattice portion and the terminal collection plate. The weld surface may be imagined to be a geometrical element or plane on which the locations of the weld points may be imagined to lie. Thus the lattice portion and the terminal collection plate may be said to be welded together at a plurality of weld points located on the weld surface.

A subsequent (e.g. the second) weld point may be spatially distanced from the first weld point to manage the heat input to the busbar assembly caused by the laser welding. For example, welding at a first weld point may cause localised heating at that weld point. The subsequent (second weld point) may then be made at a location which is in a cool region compared with the higher temperature at the first weld point. The dissipation of heat generated by the welding process may be aided by a welding pattern which spaces out the points of local heating arising due to welding, for a plurality of weld points on the busbar assembly. Such a welding pattern, in which a subsequent weld point location is located at a place which is heated by a lesser extent by laser welding at a previous location, may reduce the localised heating at weld locations compared with other welding patterns which do not consider welding in cooler locations to reduce the overall heating of the elements being welded—for example a welding pattern which moves linearly from one side of the busbar assembly to the other in a one directional way.

The first weld point and the second weld point may be in a peripheral region of the busbar assembly, and the third weld point may be in a central region of the busbar assembly. The peripheral region may be, for example, an outermost row of welds, a plurality of outermost rows of welds, or a percentage (or other proportional measure) of the total area located at the periphery of the busbar assembly.

A plurality of weld points may be located between the first and second weld points. The plurality of weld points located between the first and second weld points may be neighbouring each other.

Welding the plurality of terminal connection tabs to respective electrical terminals of a plurality of electrical cells may comprise controlling the laser welding system to control a laser beam generated by the laser welding system to produce a weld path comprising a predetermined shape, wherein the laser welding system is configured to control the beam to oscillate elliptically about the weld path.

The first weld point may be located at a first edge region of the busbar assembly, and the second weld point may be located in a second edge region of the busbar assembly, opposite the first edge region.

The method of laser welding may comprise welding the lattice portion and the terminal collection plate together at a plurality of weld points of a peripheral region of the busbar assembly; and welding the lattice portion and the terminal collection plate together at a plurality of weld points of an inner region, within the peripheral region, of the busbar assembly.

The busbar assembly may comprise a plurality of corners, and the method of laser welding may comprise welding the lattice portion to the terminal collection plate together by welding the lattice portion and the terminal collection plate together at weld points located at each of the plurality of corners of the weld surface. The method of laser welding may comprise, after welding the lattice portion and the terminal collection plate together at the weld points located at each of the plurality of corners of the weld surface, welding the lattice portion and the terminal collection plate together at a plurality of inner weld points of an inner region of the busbar assembly.

The method of laser welding may comprise welding the lattice portion and the terminal collection plate together at a plurality of weld points located along a weld path which spirals towards the centre of the busbar assembly.

Welding the lattice portion and the terminal collection plate together at a plurality of inner weld points of an inner region of the busbar assembly may comprise welding a plurality of weld points along a first weld point path in a first direction, the first weld point path located inside a peripheral region of the busbar assembly; and welding at least one further plurality of weld points along at least one further weld point path in a second direction opposite the first direction, wherein the further weld point path is located within the first weld point path. For example, the welding path may spiral towards the centre from the outer edge of the busbar assembly, on an alternating clockwise-anticlockwise path. As another example, the welding path may take a raster scan path back and forth along an edge, then an opposite edge, then back along the interior of the first edge, then back along the interior of the opposite edge, for example.

The busbar assembly may be substantially planar. The method of laser welding may be performed without using an external clamping member to forcibly clamp the lattice portion to the terminal collection plate during welding. The first and second weld points may each form clamping points acting to clamp the lattice portion to the terminal collection plate at the respective weld points.

The lattice portion and the terminal collection plate may be each substantially flat in a rectangular plane, having a width of between 80 mm and 95 mm, and having a length of between 80 mm and 95 mm. The lattice portion may have different dimensions than the terminal collection plate, and/or one or more of the lattice portion and the terminal collection plate may be square. For example, the lattice portion may have dimensions 88 mm×89 mm, and the collection plate may have dimensions 85 mm×85 mm. In other examples the lattice portion and the terminal collection plate may have substantially the same dimensions. After welding, the busbar assembly may be distorted out of the flat plane of less than 0.2 mm.

In a further aspect there is provided a busbar assembly comprising a lattice portion and a terminal collection plate, where the lattice portion is welded to the terminal collection plate according to any method disclosed herein.

In a further aspect there is provided a battery module comprising:
a busbar assembly as disclosed herein; and
a plurality of electrical cells each having a first end surface, wherein a first terminal of each cell is located in a central region of the first end surface;
wherein a plurality of terminal connection tabs protruding from the lattice portion of the busbar assembly are each welded to the central region of the first end surface of respective cells of the plurality of electrical cells.

The plurality of electrical cells of the battery module may each have at least part of a second terminal located in a peripheral region of the first end surface, and may have a second plurality of terminal connection tabs protruding from a further lattice portion of the busbar assembly which are each welded to the peripheral region of the first end surface of respective cells of the plurality of electrical cells.

In a further aspect there is provided a control system comprising one or more controllers, the control system configured to control a laser welding system to perform a welding process to laser weld a lattice portion of a busbar assembly, the lattice portion comprising copper, to a terminal collection plate of the busbar assembly, the terminal collection plate comprising aluminium, at a plurality of weld points located on a weld surface by:
welding the lattice portion and the terminal collection plate together at a first weld point;
welding the lattice portion and the terminal collection plate together at a second weld point; and
welding the lattice portion and the terminal collection plate together at a third point in a region formed between the first and the second weld point.

In some examples, the lattice portion of the busbar assembly need not necessarily comprise copper. In some examples, the terminal collection plate of the busbar assembly need not necessarily comprise aluminium.

In a further aspect there is provided a vehicle comprising a battery module as disclosed herein.

In a further aspect there is provided a method of manufacturing a battery module, the battery module comprising a plurality of electrical cells and a busbar assembly comprising a terminal collection plate and a lattice portion, the lattice portion comprising a plurality of terminal connection tabs, the method comprising:
controlling a welding system to perform a welding process to:
   weld the terminal collection plate to the lattice portion at a plurality of busbar welds to form the busbar assembly; and
   weld the plurality of terminal connection tabs to respective electrical terminals of the plurality of electrical cells, wherein each terminal connection tab is welded to each respective electrical terminal by a terminal weld,
      wherein a first distance is a distance along an electrical path on the lattice portion between one of the plurality of terminal welds and the closest of one of the plurality of busbar welds, and wherein the first distance for each terminal weld is substantially electrically equivalent.

In some examples, the first distance may be the same distance for all the terminal welds. In other examples, the first distance between a terminal weld and the closest busbar weld may differ for different terminal welds, but, the distance still provides electrical equivalence for all the terminal welds (by electrical equivalency, it may be taken to mean that the electrical resistance of the path between the terminal weld and the closest of the busbar welds having a distance equal to the first distance (i.e. separated by the first distance) is the same for all terminal weld-closest busbar weld pairs.

The lattice portion comprising a plurality of tabs may also be called a metallic plate in some examples.

Each terminal connection tab may have substantially the same cross sectional area, and thereby a resistance of each electrical path in the battery module may be substantially the same. The cross sectional area may be taken through the sheet of material forming the terminal connection tab (i.e. for a flat/planar tab, the cross section may be taken substantially perpendicular to the plane of the tab). The resistance R of the electrical path is proportional to the resistivity Ro x distance (path length) L x cross-sectional area of the tab CSA. The distance (path length) L may be taken to be from the centre of the weld connecting the electrical cell terminal to the terminal connection (the terminal weld), to the centre of the nearest weld connecting the lattice portion to the terminal collection plate (the busbar weld).

The welding system may be a laser welding system, and the welding process may be a laser welding process.

Welding the plurality of terminal connection tabs to respective electrical terminals of the plurality of electrical cells may comprise controlling the laser welding system to control a laser beam generated by the laser welding system to produce a weld path comprising a predetermined shape, wherein the laser welding system is configured to control the beam to oscillate elliptically about the weld path. The predetermined shape may be a continuous loop. Optionally the continuous loop may comprise a disco-rectangle shape (i.e. a “racetrack” or “stadium” shape).

Welding the terminal collection plate to the lattice portion at a plurality of busbar welds may comprise controlling the laser welding system to control a laser beam generated by the laser welding system to produce a plurality of weld spots of a substantially circular spot shape to form the plurality of busbar welds.

Welding the terminal collection plate to the lattice portion may comprises: welding the lattice portion and the terminal collection plate together at a first busbar weld point; welding the lattice portion and the terminal collection plate together at a second busbar weld point; and welding the lattice portion and the terminal collection plate together at a third busbar weld point in a region formed between the first and the second busbar weld points. The first busbar weld point and the second busbar weld point may be in a peripheral region of the busbar assembly, and the third busbar weld point may be in a central region of the busbar assembly.

The terminal collection plate may comprise aluminium. The lattice portion may comprise copper. The lattice portion may comprise metal passivated copper.

In a further aspect there is provided a battery module comprising:
a plurality of electrical cells;
a terminal collection plate; and
a lattice portion comprising a plurality of terminal connection tabs; wherein the terminal collection plate is welded to the lattice portion at a plurality of busbar welds to form a busbar assembly;
the plurality of terminal connection tabs are each welded to respective electrical terminals of the plurality of electrical cells by a terminal weld; and
a first distance is a distance along an electrical path on the lattice portion between one of the plurality of terminal welds and the closest of one of the plurality of busbar welds, and wherein the first distance for each terminal weld is substantially the electrically equivalent.

Each terminal connection tab may have substantially the same cross sectional area, and thereby a resistance of each electrical path in the battery module may be substantially the same.

Each terminal weld may comprise a predetermined shape. The predetermined shape may be a continuous loop. The continuous loop may comprise a disco-rectangle shape.

A plurality of busbar welds may each be a spot weld point having a substantially circular spot shape.

The lattice portion may have a width of between 60 mm and 120 mm; preferably between 80 mm and 90 mm. The lattice portion may have a length of between 60 mm and 120 mm; preferably between 80 mm and 90 mm. The terminal collection plate may have a width of between 60 mm and 120 mm; preferably between 80 mm and 90 mm. The terminal collection plate may have a length of between 60 mm and 120 mm; preferably between 80 mm and 90 mm.

The plurality of electrical cells may each have a first end surface, wherein a first electrical terminal of each cell is located in a central region of the first end surface. The plurality of terminal connection tabs may be protruding from the lattice portion of the busbar assembly and may each be welded to the central region of the first end surface of respective electrical cells of the plurality of electrical cells.

The plurality of electrical cells may each have at least part of a second terminal located in a peripheral region of the first end surface. A second plurality of terminal connection tabs may be protruding from a further lattice portion of the busbar assembly and may each be welded to the peripheral region of the first end surface of respective electrical cells of the plurality of electrical cells.

In a further aspect there is provided a battery pack comprising a plurality of battery modules as disclosed herein.

In a further aspect there is provided a vehicle comprising a battery module as disclosed herein, or a battery pack as disclosed herein.

In a further aspect there is provided a control system comprising one or more controllers, the control system configured to control a welding system to perform a welding process to manufacture a battery module comprising a plurality of electrical cells and a busbar assembly, the busbar assembly comprising a terminal collection plate and a lattice portion, the lattice portion comprising a plurality of terminal connection tabs, by control a welding system to:
weld the terminal collection plate to a lattice portion at a plurality of busbar welds to form the busbar assembly; and
weld the plurality of terminal connection tabs to respective electrical terminals of the plurality of electrical cells, wherein each terminal connection tab is welded to its respective electrical terminal by a terminal weld,
wherein a first distance is a distance along an electrical path on the lattice portion between one of the plurality of terminal welds and the closest of one of the plurality of busbar welds, and wherein the first distance for each terminal weld is substantially electrically equivalent.

In a further aspect there is provided a provided computer software that, when executed, is arranged to perform any method described herein. The computer software may be stored in a micro-controller, firmware, and/or on a computer readable medium, and be therefore recorded on a non-transient computer readable medium. That it, the computer software may be tangibly stored on a computer readable medium.

Within the scope of this application it is expressly intended that the various aspects, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Examples will now be described by way of example only, with reference to the accompanying figures, in which:

FIG. 1 shows a block of electrical cells bonded together according to examples disclosed herein;

FIGS. 2a and 2b show a block of electrical cells with each cell terminal welded to a respective terminal connection tab according to examples disclosed herein;

FIG. 3a shows an exploded view of a busbar assembly comprising a terminal collection plate and a lattice portion according to examples disclosed herein;

FIG. 3b shows a view of a busbar assembly comprising a terminal collection plate welded to a lattice portion according to examples disclosed herein;

FIG. 4 shows a flow chart illustrating a method of laser welding a lattice portion of a busbar assembly according to examples disclosed herein;

FIG. 5a-5c show weld point locations and weld ordering on the busbar assembly according to examples disclosed herein;

FIG. 6 shows a control system according to examples disclosed herein;

FIG. 7 shows a flow chart illustrating a method of manufacturing a battery module according to examples disclosed herein;

FIGS. 8a-8b illustrate views of a busbar assembly of FIG. 3b, indicating weld points of the terminal connection tabs to the respective electrical cell terminals, according to examples disclosed herein;

FIG. 9 shows a control system according to examples disclosed herein; and

FIG. 10 shows a vehicle according to examples disclosed herein.

### DETAILED DESCRIPTION

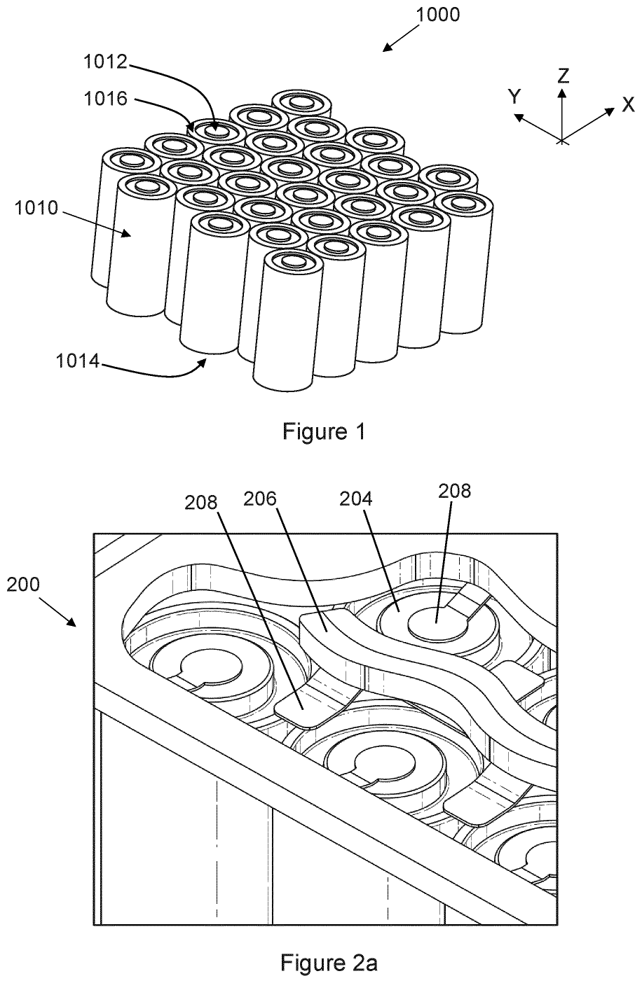

FIG. 1 shows a block 1000 comprising a plurality of cylindrical cells 1010. The cells may be mechanically joined together, for example via an adhesive on the cylindrical surfaces of the cells 1010. The cylindrical cells 1010 may be arranged in a side-to-side configuration. The block 1000 may comprise rows of cells 1010, with each row being offset from the adjacent rows by a distance approximately equal to the radius of one of the cylindrical cells, thereby improving the efficiency with which the cells can be packaged into a given volume. It will be understood that other configurations of the block 1000 are also useful, and in some examples, the cells need not be cylindrical.

The cylindrical cells 1010 are widely available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used.

Each cell 1010 comprises a positive terminal and a negative terminal. The positive terminal may be provided by an end cap (e.g. a steel, or an aluminium, end cap) in a central region of the first end 1012 of the cell. The negative terminal in some examples may be provided by a steel cylindrical cap or plate at the second end 1014.

The negative terminal in some examples may be provided by a steel cylindrical case which covers the second end 1014, the entire cylindrical surface between the first 1012 and second ends 1014, and a peripheral region 1016 of the first end surface 1012. The peripheral region 1016 of the first end surface 1012 may also be referred to as a “shoulder” region of the first end surface 1012. In commercially-available cells, it is sometimes the case that the end cap that defines the positive terminal on the first end surface 1012 protrudes beyond the shoulder region 1016 of the first end surface 1012, although this is not the case in the cells shown in FIG. 1.

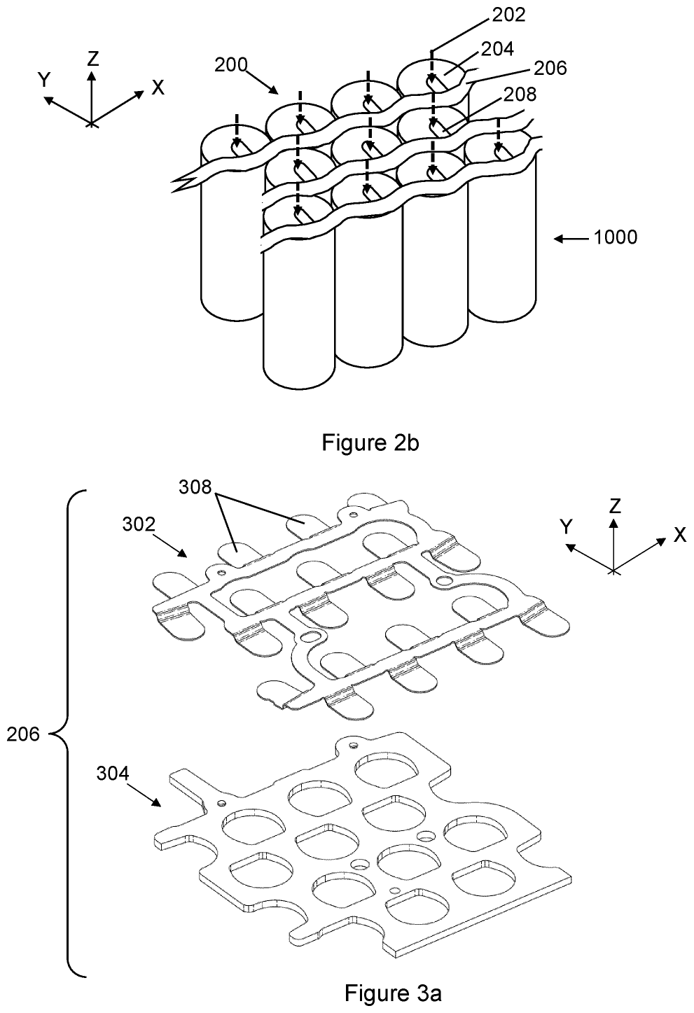

FIGS. 2a and 2b show a portion of an assembly 200 (which may be termed a battery module 200) comprising a block 1000 of electrical cells 1010 as shown in FIG. 1, with each cell terminal 204 welded to a respective terminal connection tab 208. The terminal connection tabs 208 are part of a single-sided busbar assembly 206 which is provided adjacent to the first ends 112 of the cells 1010. The busbar assembly 206 is discussed below as comprising a lattice portion, and the terminal connection tabs 208 are part of the lattice portion. The lattice portion is welded to a terminal collection plate, as discussed below, to form the busbar assembly 206. The lattice portion may comprise, or may be, copper. The terminal collection plate may comprise, or may be, aluminium. Thus, FIGS. 2a and 2b show a battery module 200 comprising a busbar assembly 206 as disclosed herein, and a plurality of electrical cells 1010 each having a first end surface 1012, wherein a first terminal 204 of each cell is located in a central region of the first end surface 1012. A plurality of terminal connection tabs 208 protruding from the lattice portion of the busbar assembly 206 are each welded to the central region of the first end surface 1012 of respective cells of the plurality of electrical cells 1010.

The busbar assembly 206 is configured to electrically connect to the terminals of a type (e.g. the positive terminals, or the negative terminals) of all of the cells. The busbar assembly 206 may, for example in an example connecting to the negative terminals of the cells, comprise a negative terminal collection plate (e.g. comprising aluminium) and connect to the negative terminals of the cells by a thin metallic sheet forming the lattice portion (e.g. comprising copper, for example copper plated with nickel). The busbar assembly 206 may, for example if connecting to the positive terminals of the cells, comprise a positive terminal collection plate (e.g. comprising aluminium) and connect to the positive terminals of the cells by a thin metallic sheet forming the lattice portion (e.g. comprising copper, for example copper plated with nickel).

In examples in which the positive terminals of the cells are located at one face of the assembly 200 and the negative terminals of the cells are located at an opposite face of the assembly 200, there may be two busbar assemblies 206—one to connect to the positive terminals and another to connect to the negative terminals. In examples in which the positive and the negative terminals of the cells are located at the same face of the assembly 200 (for example, the positive terminals are located in the centre of each of the cell ends, and the negative terminals are located at a shoulder region of the same cell ends), there may one busbar assembly 206 comprising both a positive terminal collection plate and a negative terminal collection plate, each having respective thin metal sheets (lattice portions) by which to connect to the corresponding terminals. In such a single busbar assembly 206 example, an insulating layer should be positioned between the negative terminal collection plate and corresponding thin metallic sheet, and the positive terminal collection plate and corresponding thin metallic sheet, to ensure that the positive and negative collection plates are electrically isolated from one another. That is, in some examples, the plurality of electrical cells 1010 of the battery module 200 may each have at least part of a second terminal located in a peripheral region 1016 of the first end surface 1012, and may have a second plurality of terminal connection tabs 208 protruding from a further lattice portion of the busbar assembly 206 which are each welded to the peripheral region 1016 of the first end surface 1012 of respective cells of the plurality of electrical cells 1010.

The busbar assembly 206 comprises a plurality of connection tabs 208 (e.g. formed from the thin metallic sheet) extending away from the body of the corresponding collection plate (that is, a plurality of positive terminal connection tabs (formed from the thin metallic sheet bonded to the positive collection plate) extend away from the body of the positive collection plate, and/or a plurality of negative terminal connection tabs (formed from the thin metallic sheet bonded to the negative collection plate) extend away from the body of the negative collection plate). The connection tabs 208 can be welded to the corresponding terminals of the cells in the group of cells 1010, and the positioning of the connection tabs is such that each cell 1010 can be connected to a respective connection tab 208 when the busbar assembly 206 is correctly positioned relative to the group of cells 1010.

The busbar assembly 206 may be positioned adjacent to the group of cells 1010 such that the positive and/or negative connection tabs 208 are in contact with the corresponding positive and/or negative terminals of the cells within the group of cells 1010. The connection tabs 208 are then electrically and mechanically connected to the respective terminals by laser welding. It will be understood that other methods of electrically and mechanically connecting the connection tabs to the terminals, including but not limited to other welding techniques, are also useful.

Each of the connection tabs 208 is positioned adjacent to a respective terminal of a single cell within the group of cells 1010, and a portion of the connection tab may be laser welded to the respective terminal. When laser welding the connection tabs 208 to the respective terminals, it is important to control the amount of energy used in the weld to ensure that the internal components of the cells are not damaged by the heat generated during the welding process. Accordingly, laser welding may be a particularly suitable technique, as it enables precise control of the amount of energy applied during each weld operation. Welding the plurality of terminal connection tabs 308 to respective electrical terminals 204 of a plurality of electrical cells 1010 may comprise controlling the laser welding system to control a laser beam generated by the laser welding system to produce a weld path comprising a predetermined shape, wherein the laser welding system is configured to control the beam to oscillate elliptically about the weld path.

Ensuring that the connection tabs 208 are in good electrical and mechanical contact with the respective terminals during welding the connection tabs to the respective terminals (and thus once welding has been performed) is important for the operation of the assembly 200.

The lattice portion and the and terminal collection plate of the busbar assembly 206 may be joined together by welding, e.g. laser welding, where the laser beam provides a concentrated heat source to fuse the parent materials of the lattice portion and the and terminal collection plate. Laser welding may desirably allow for narrow, deep welds to be formed with high production rates. An issue may arise when laser welding the assembly together due to localised heating at the weld point, which may cause distortion, which may be significant, of the busbar assembly. For example, it may be desirable to obtain a planar busbar assembly, and warping due to localised heating during welding the lattice portion to the terminal collection plate to form the busbar assembly may cause the busbar assembly to adopt a non-planar shape. A non-planar busbar assembly may make it more difficult to accurately and securely weld the terminal connection tabs of the busbar assembly to the cell array compared with a substantially planar busbar assembly.

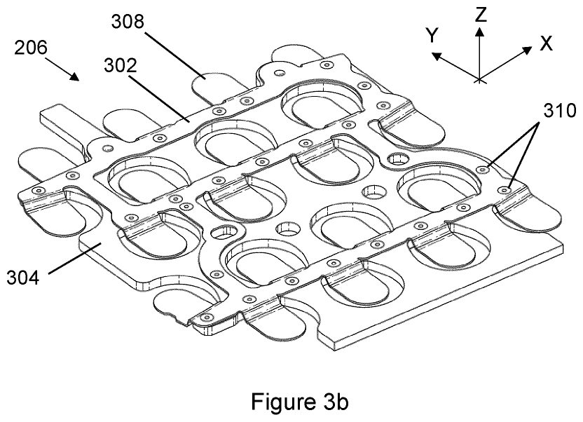

FIG. 3a shows an exploded view of a busbar assembly 306 comprising a terminal collection plate 304 and a lattice portion 302 prior to welding the two together. FIG. 3b shows a view of a busbar assembly 306 comprising a terminal collection plate 304 welded to a lattice portion 302 at a plurality of busbar weld locations 310. These views represent an example of a realistic form of busbar assembly. The order of making the busbar weld locations 310 to join the terminal collection plate 304 to the lattice portion 302 may be made in a way which may reduce the distortions which arise due to localised heating of the busbar assembly 306 caused by (laser) welding.

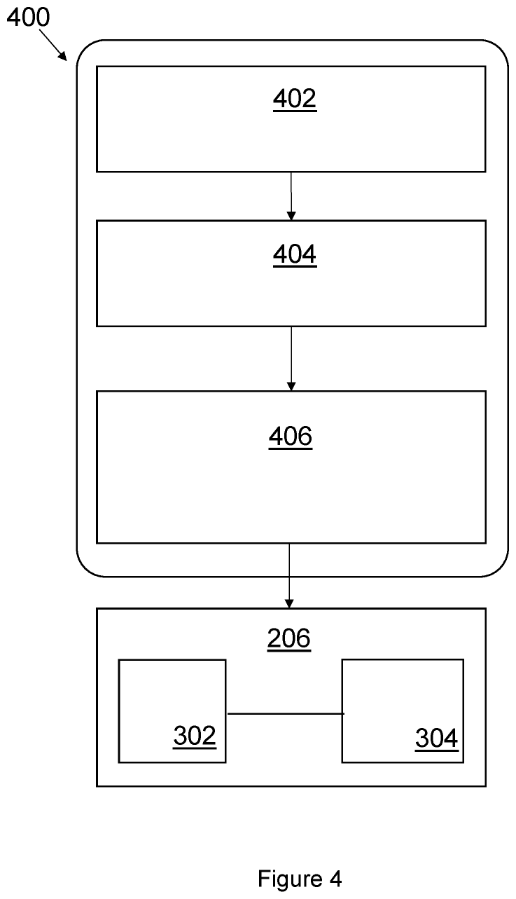

FIG. 4 shows a flow chart illustrating a method of laser welding 400 a lattice portion of a busbar assembly 206, which may address the issue of busbar assembly distortions arising due to heating effects arising during welding. In some examples, the lattice portion may comprise copper, and is welded to a terminal collection plate of the busbar assembly. The terminal collection plate may comprise aluminium in some examples.

The method 400 comprising controlling a laser welding system to perform a welding process to weld the lattice portion 302 and the terminal collection plate 304 together at a plurality of weld points by: welding the lattice portion and the terminal collection plate together at a first weld point 402; welding the lattice portion and the terminal collection plate together at a second weld point 404; and welding the lattice portion and the terminal collection plate together at a third point in a region formed between the first and the second weld point 406.

Between the first weld point and a subsequent weld point, the busbar assembly 206, at the subsequent weld point may be at a lower temperature than the busbar at the first position, due to the welding of the first point causing localised heating of the busbar assembly 206 at the first position. Welding the lattice portion 302 and the terminal collection plate 304 together at a first weld point 402 may cause a temperature gradient having a localised high temperature region at the first weld point and a low temperature region elsewhere. A subsequent weld point may then be located at a low temperature region of the weld surface, which is spatially distanced from the localised high temperature region, to reduce any further localised heating effect, and thereby, reduce any spatial distortion of the busbar assembly 206 due to localised heating.

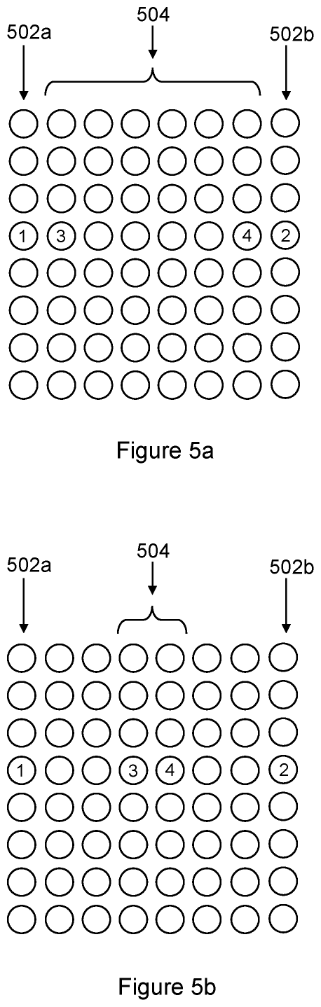

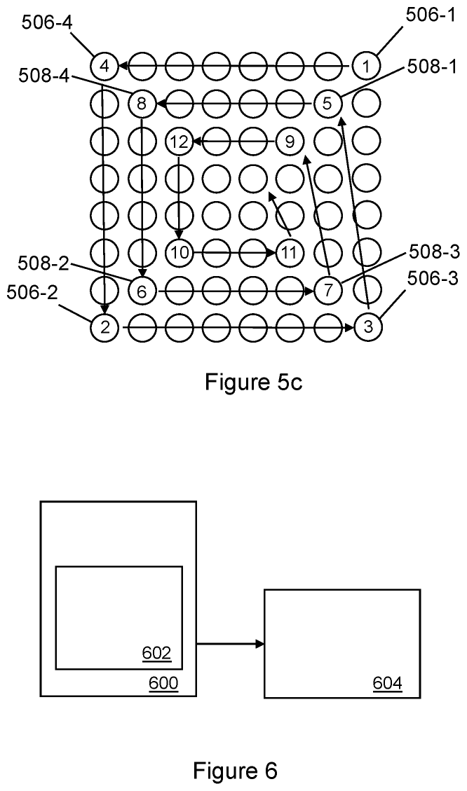

FIG. 5a-5c show schematically a series of example weld point locations 500 and weld ordering on the busbar assembly. Each weld point location 500 is illustrated by a circle in a square grid in these examples, but it will be appreciated that this square weld point location layout is shown for simplicity, and a real-world weld point location grid/arrangement may be more like the busbar weld points 310 locations shown in FIG. 3b. Furthermore, the examples of FIGS. 5a and 5b show weld points along a straight one dimensional line, whereas in a real world example, a distribution of weld points over a two dimensional plane may be made (as shown in FIG. 5c).

In these examples, the first weld point (labelled “1”) and the second weld point (labelled “2”) are in a peripheral region 502a, 502b of the busbar assembly, and the third weld point (labelled “3”) is in a central region 504 of the busbar assembly. The peripheral region 502a, 502b may be, for example, an outermost row of welds (that is, located proximal to the edge of the busbar assembly) as illustrated in FIGS. 5a-5c, a plurality of outermost rows of welds, or a percentage (or other proportional measure) of the total area located at the periphery of the busbar assembly.

In FIG. 5a, a first weld point “1” is located on a left edge 502a of the busbar assembly. The second weld point “2” is located on the opposite, right, edge 502b of the busbar assembly. By locating these first two weld points at opposite edges of the busbar assembly, the method of laser welding may be performed without using an external clamping member to forcibly clamp the lattice portion to the terminal collection plate during welding. This is because the first and second weld points “1” and “2” may each form clamping points, acting to clamp (or fix) the lattice portion to the terminal collection plate at the respective weld points—in this example, at the opposite outer edges. In this way, subsequent welds may be made between these two initial weld points and the lattice portion and terminal collection plate are fixed in place relative to each other by the initial welds to aid in accurate welding. Other example initial welding positions (e.g. diametrically opposite corners) may also allow the busbar assembly components to be welded together without requiring an external clamping member. It may be desirable in some examples to be able to perform welding without an external clamping member, which may in some circumstances exert forces which undesirably contribute to distortion of the busbar assembly. In some examples, due to the initial welds acting to hold the busbar components together in place, a clamping member may still be used but with a lower clamping force applied than in examples where the clamping member is predominantly relied on for retaining the busbar assembly components in place during welding.

A plurality of weld points may be located between the first and second weld points, as also shown in FIGS. 5a-5c. The plurality of weld points (e.g. points “3” and “4”) located between the first and second weld points (e.g. points “1” and “2”) may be neighbouring each other in some examples, as in FIG. 5b.

In FIG. 5a, after the initial two weld points are made, at a left edge then a right edge, the third weld may be made away from the second weld, in this example, at the next weld point row inside from the left edge 502a where the first weld was made. In this way, localised heating caused by the first weld at location “1” has had time to cool while the second weld at location “2” is formed at the opposite edge 502b, and while the second weld is cooling, the subsequent third weld “3” is again made away from the most recent second weld to reduce further contributions to local heating at location “2”. The weld pattern may continue in this way moving back and forth over the busbar assembly, gradually moving towards the centre of the busbar assembly. As subsequent welds are closer together, the separation of successive weld points may decrease and as such the effect of reducing contributions to localised heating may also decrease. However, since these welds are made following previous welds outside these welds, the previous welds act to pin the busbar assembly into position, and the more welds are made (and thus the closer subsequent weld points become), the more weld points are already formed to pin the busbar assembly into position.

Thus this ordering of weld points may be considered to be advantageous, as the mitigating effects of spatially separating subsequent weld points decreases as the number of existing weld points acting to stabilise the shape of the busbar assembly increase.

In FIG. 5b, after the initial two weld points “1” and “2” are made at peripheral locations 502a and 502b respectively, as in FIG. 5a (i.e. at a left edge then a right edge), the third weld may be made away from the second weld, in this example, at central weld point approximately equidistant from the first two weld points in the centre 504 of the busbar assembly. In this example, two further central weld points “3” and “4” are illustrated, wherein point “3” is located closer to point “1” and point “4” is located closer to point “2”, wherein both points “3” and “4” are substantially centrally located in the busbar assembly. In this way, localised heating caused by the first weld at location “1” has had time to cool while the second weld at location “2” was formed, and while the second weld is cooling, the subsequent third welds “3” and “4” are made away from the welds already formed, at the first and second weld points “1” and “2”. This may act to reduce further contributions to local heating at locations “1” and “2”, and since welds at points “1” and “2” are made to pin the edges of the lattice portion 302 to the terminal collection plate of the busbar assembly in place, distortions to the busbar assembly due to localised heating may be mitigated against since the edges are already locked into place.

Thus in these examples of FIGS. 5a-5c, the first weld point may be located at a first edge region 502a of the busbar assembly, and the second weld point may be located in a second edge region 502b of the busbar assembly, opposite the first edge region 502a. Further, these examples illustrate welding the lattice portion 302 and the terminal collection plate 304 together at a plurality of weld points of a peripheral region 502a, 502b of the busbar assembly; and welding the lattice portion 302 and the terminal collection plate 304 together at a plurality of weld points of an inner region 504, within the peripheral region 502a, 502b, of the busbar assembly.

As shown in FIG. 5c, the busbar assembly may comprise a plurality of corners 506-1 to 506-4, and the method of laser welding may comprise welding the lattice portion 302 to the terminal collection plate 304 together by welding the lattice portion 302 and the terminal collection plate 304 together at weld points located at each of the plurality of corners of the weld surface 506-1 to 506-4. The method of laser welding may comprise, after welding the lattice portion 302 and the terminal collection plate 304 together at the weld points located at each of the plurality of corners of the weld surface 506-1 to 506-4, welding the lattice portion 302 and the terminal collection plate 304 together at a plurality of inner weld points 508-1 to 508-4 of an inner region of the busbar assembly.

The method of laser welding may comprise welding the lattice portion 302 and the terminal collection plate 304 together at a plurality of weld points located along a weld path which spirals towards the centre of the busbar assembly. This is illustrated schematically in FIG. 5c. FIG. 5c shows a first peripheral series of weld points 506-1 to 506-4 are made at the top right (506-1), bottom left (506-2), bottom right (506-3) and top left (506-4). Thus, in this example, the first welds are made at the corners of the busbar assembly by welding opposite corner pairs. Following this, a second series of weld points are made within the first series of weld points, also in this example by welding at opposite corner pairs at the top right (508-1), bottom left (508-2), bottom right (508-3) and top left (508-4). By continuing in this way a series of loops are formed which may be said to spiral towards the centre of the busbar assembly from the periphery. Of course in other examples, other welding patterns may also be made which form a spiral towards the centre of the busbar assembly, such as welding, for example, in the order: top right (506-1), top left (506-4), bottom left (506-2), then bottom right (506-3) in a series of concentric-type loops.

A further example is of first welding in a clockwise loop, followed by welding in a counter-clockwise loop within the first loop, and continuing to alternate rotation direction while welding loops moving towards the centre of the busbar assembly. In this way the welding path may spiral towards the centre from the outer edge of the busbar assembly 206, on an alternating clockwise-anticlockwise path. In other words, welding the lattice portion 302 and the terminal collection plate 304 together at a plurality of inner weld points 508-1 to 508-4 of an inner region of the busbar assembly 206 may comprise welding a plurality of weld points 508-1 to 508-4 along a first weld point path in a first direction, the first weld point path located inside a peripheral region 502a, 502b of the busbar assembly 206; and welding at least one further plurality of weld points along at least one further weld point path in a second direction opposite the first direction, wherein the further weld point path is located within the first weld point path. As another example, the welding path may take a raster scan path back and forth along an edge, then an opposite edge, then back along the interior of the first edge, then back along the interior of the opposite edge. Other possible welding patterns may also be envisaged, which allow for a reduced localised heating effect by separating successive weld spots from each other, which allow for the lattice portion and the terminal collection plate 304 to be fixed together at peripheral points in the initial series of welds which may help reduce distortions due to heating from the welding process, and which are possible using a straightforward control system to move the weld points around on the busbar assembly in a well-controlled and accurate way

The lattice portion 302 and the terminal collection plate 304 may, in some examples, be each substantially flat in a rectangular plane, having a width of between 80 mm and 95 mm, and having a length of between 80 mm and 95 mm. The lattice portion may have different dimensions than the terminal collection plate 304, and/or one or more of the lattice portion and the terminal collection plate may be square. For example, the lattice portion may have dimensions 88 mm×89 mm, and the collection plate may have dimensions 85 mm×85 mm. In other examples the lattice portion 302 and the terminal collection plate 304 may have substantially the same dimensions. After welding according to examples disclosed herein, acting to reduce distortions in the busbar assembly by mitigating against local heating effects due to welding, the busbar assembly 206 may be distorted out of the flat plane of less than 0.2 mm.

FIG. 6 shows a control system 600 comprising one or more controllers 602. The control system 600 is configured to control a laser welding system 604 to perform a welding process to laser weld a lattice portion 302 of a busbar assembly 206 (which may comprise copper in some examples), to a terminal collection plate 304 of the busbar assembly 206 (which may comprise aluminium in some examples), at a plurality of weld points located on a weld surface. The control system 600 is configured to do so as discussed above, by: welding the lattice portion 302 and the terminal collection plate 304 together at a first weld point; welding the lattice portion 302 and the terminal collection plate 304 together at a second weld point; and welding the lattice portion 302 and the terminal collection plate 304 together at a third point in a region formed between the first and the second weld point.

The controller(s) 602 may each comprise a control unit or computational device having one or more electronic processors. A single control system 600 or electronic controller 600 may be used, or alternatively, different functions of the control system 600 may be embodied in, or hosted in, different controllers 602. A set of computer-readable instructions may be provided which, when executed, cause said controller(s) 602 or control module 600 to implement the methods described herein. The set of instructions may be embedded in one or more electronic processors, or alternatively, the set of instructions could be provided as software to be executed by one or more electronic processor(s). For example, a first controller 602 may be implemented in software run on one or more electronic processors, and one or more other controllers may also be implemented in software run on one or more electronic processors, or, optionally, on the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

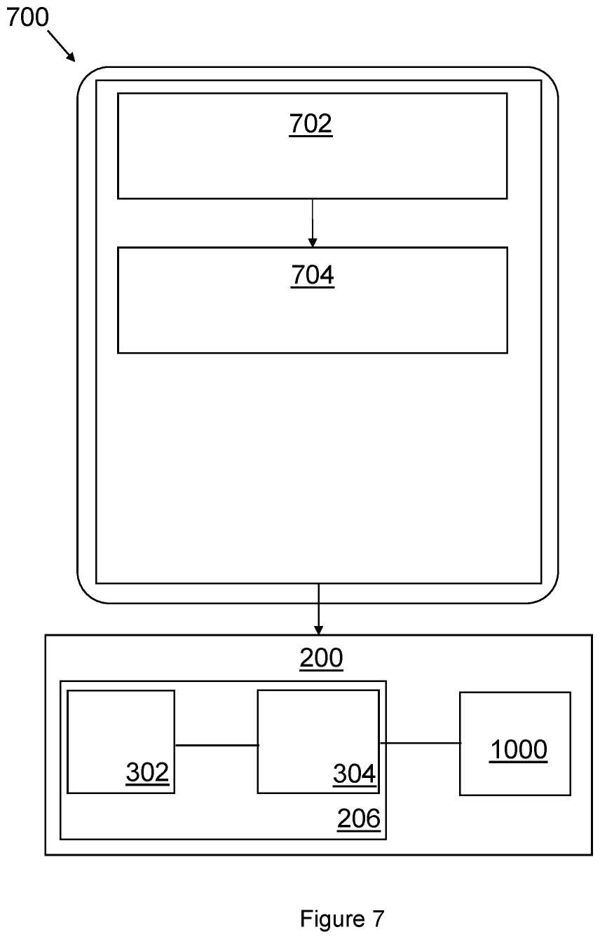

FIG. 7 shows a flow chart illustrating a method of manufacturing a battery module 300. The battery module 300 comprises a plurality of electrical cells 1010 and a busbar assembly 206. The busbar assembly 206 comprises a terminal collection plate 304 and a lattice portion 302. The lattice portion 302 comprises a plurality of terminal connection tabs 308. The terminal collection plate 304 may comprise aluminium. The lattice portion 802 may comprise copper. The lattice portion may comprise metal (e.g. nickel) passivated copper.

The method 700 comprises controlling a welding system to perform a welding process to: weld 702 the terminal collection plate 304 to the lattice portion 302 at a plurality of busbar welds 310 to form the busbar assembly 206; and weld 704 the plurality of terminal connection tabs 308 to respective electrical terminals of the plurality of electrical cells 1010. Each terminal connection tab 308 is welded to each respective electrical terminal by a terminal weld. A first distance is a distance along an electrical path on the lattice portion 302 between one of the plurality of terminal welds and the closest of one of the plurality of busbar welds 310. The first distance for each terminal weld is substantially electrically equivalent.

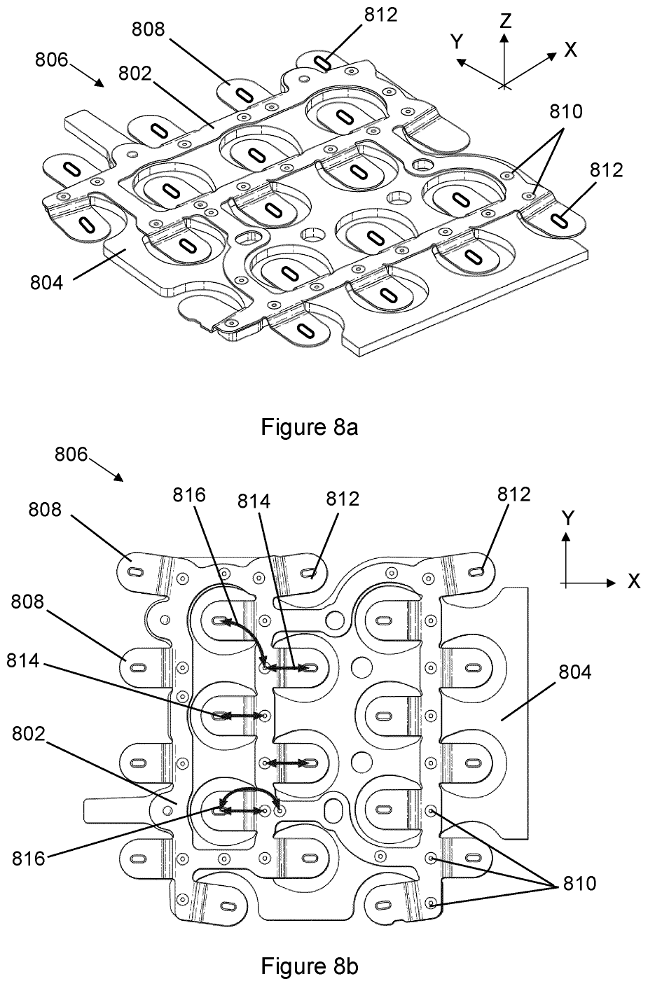

FIGS. 8a-8b illustrate views of a busbar assembly 806 as in FIG. 3b, indicating busbar weld points 810 and weld points 812 of the terminal connection tabs 808 to the respective electrical cell terminals. Similar elements to those in FIG. 3b are indicated with similar reference numerals. While the electrical cells are not illustrated here, the terminal welds 218 by which each terminal connection tab 808 would be welded to an electrical cell terminal in a battery module are shown. It can be seen that each terminal connection tab 808 would be welded to a respective electrical terminal by a terminal weld 812. The lattice portion 802 may have a width of between 60 mm and 120 mm; preferably between 80 mm and 90 mm. The lattice portion 802 may have a length of between 60 mm and 120 mm; preferably between 80 mm and 90 mm. The terminal collection plate 804 may have a width of between 60 mm and 120 mm; preferably between 80 mm and 90 mm. The terminal collection plate 804 may have a length of between 60 mm and 120 mm; preferably between 80 mm and 90 mm.

The first distance 814 along an electrical path on the lattice portion 802 between one of the plurality of terminal welds 812 and the closest of one of the plurality of busbar welds 810 may be seen in FIG. 8b, and this first distance 814, for each terminal weld 812 (i.e., for each terminal connection tab 808), is substantially electrically equivalent. In the example of FIGS. 8a and 8b, the first linear distance 814 is substantially the same distance (e.g. 5 mm+a tolerance error) for all the terminal welds 812 (it can be seen that each busbar weld 810 which acts as a weld point closest to a terminal weld 812 is located along a finger portion of the lattice portion 802 from which the terminal connection tabs 808 extend approximately perpendicularly, and that each terminal weld 812 is closest to a busbar weld 810 which is substantially centrally positioned with respect to the portion of the lattice portion 802 connecting the terminal connection tab 808 with the terminal weld 812). That is, each terminal connection tab 808 in some examples may have substantially the same cross sectional area, and thereby a resistance of each electrical path (terminal weld 812—closest busbar weld 810 path length) in the battery module may be substantially the same.

In other examples, the first distance 814 between a terminal weld and the closest busbar weld may differ in distance for different terminal welds (that is, the first distance 814 for each terminal weld 812 may a distance between, for example, 3 mm ±a tolerance error and 7 mm±a tolerance error), but, the distance still provides electrical equivalence for all the terminal welds 812. By electrical equivalency, it may be taken to mean that the electrical resistance of the path between the terminal weld 812 and the closest of the busbar welds 810 having a distance equal to the first distance 814 (i.e. separated by the first distance 814) is the same for all terminal weld-closest busbar weld pairs. Electrical equivalence may be understood to mean a particular electrical property (e.g. resistance) having the same value for each first distance 814, even if each first distance 814 is different in linear dimension. It may be the case, for example, that a first terminal weld 812—busbar weld 810 pair have a linear separation of 5 mm, and that a second terminal weld 812—busbar weld 810 pair have a linear separation of 4 mm, but because the lattice portion material between the second terminal weld 812-busbar weld 810 pair is thicker (has a larger cross sectional area) than the first terminal weld 812—busbar weld 810 pair, both the first and second weld pairs have the same first distance 814 since they each have electrically equivalent paths (e.g. the same resistance) between their two weld points 810, 812.

Equal resistances for all cells 1010 in the array 1000 is desirable because the cells are then used in a ‘balanced’ way, i.e. if one cell route (from cell—terminal connection tab—lattice portion—terminal collection plate) has a lower resistance (e.g. a shorter length L) than for other cells, than that cell may have more current drawn from it during its lifetime and may age more quickly. This means the whole cell array (battery module) is less balanced over time than if all cells had an equal current drawn from them, and the capacity of the whole unbalanced module/pack may be reduced by the single aged cell compared with a balanced battery module. If all electrical cells in the module/pack are kept balanced then all cells age at the same rate and the pack capacity is improved compared to an unbalanced battery pack.

The cross sectional area (CSA) may be taken through the sheet of material forming the terminal connection tab 808 (i.e. for a flat/planar tab, the cross section may be taken substantially perpendicular to the plane of the tab 808). The resistance R of the electrical path may be taken to be proportional to the resistivity Ro x distance (path length) L x cross-sectional area of the tab CSA. The first distance 814 (path length) L may be taken to be from the centre of the weld connecting the electrical cell terminal to the terminal connection (the terminal weld 812), to the centre of the nearest weld connecting the lattice portion to the terminal collection plate (the busbar weld 810).

In considering the electrical equivalence of paths between proximal terminal welds 812 and busbar welds 810, other path lengths such as those of next nearest busbar welds 812, as indicated in FIG. 8b by the open arrows 816 may be substantially ignored in some examples. This is because, for the shortest weld pair separation distances 814 (or, in examples where the linear distances are not the same for all weld pairs, the paths between weld pairs of least electrical resistance) have the lowest resistance between weld points of a weld pair. The parallel addition of resistances means that next-nearest busbar weld—terminal weld paths 816 may have a small (in some cases, negligible) effect on the total current flow from the terminal weld and connected electrical cell.

However, in some examples, the next nearest busbar welds 812 may also be accounted for along with the nearest busbar welds 810 to a terminal weld 812 in determining the electrical equivalence of current flow paths in the busbar assembly 806. That is, a first distance, which is considered in obtaining an equivalent current flow from each electrical cell in the cell array 1000 to the connecting busbar assembly 806 may comprise a plurality of electrically parallel distances 814, 816 between a terminal weld 812 and a plurality of nearest neighbouring busbar welds 810. Again, the aim is to design the positioning of terminal welds 812 and busbar welds 810 which provides an electrically equivalent path from each electrical cell in the array 1000 to the busbar assembly 806 so that each electrical cell is used equivalently in the cell array 1000.

Welding the terminal collection plate 804 to the lattice portion 802 at a plurality of busbar welds 810 may comprise controlling the laser welding system to control a laser beam generated by the laser welding system to produce a plurality of weld spots of a substantially circular spot shape to form the plurality of busbar welds 810. This can be seen in FIGS. 8a-8b where the busbar welds 810 have a circular shape. Discrete circular welds may be advantageous (rather than, for example, straight line welds) because circular spots allow for more precise path lengths to be easily designed. Furthermore, circular spot welds act to, desirably, distribute heat input across the busbar assembly 806 during welding, which straight line welds may be less effective at. Also, a circular busbar weld 810 provides a high strength weld to hold the lattice portion 802 and terminal collection plate 804 together compared to other shaped welds (e.g. a straight line weld) and provides a high strength to weld size ratio compared to other weld shapes.

Welding the plurality of terminal connection tabs 808 to respective electrical terminals of the plurality of electrical cells may comprise controlling the laser welding system to control a laser beam generated by the laser welding system to produce a weld path comprising a predetermined shape. The laser welding system may be configured to control the beam to oscillate elliptically about the weld path. The predetermined shape may be a continuous loop. For example, the continuous loop may comprise a disco-rectangle shape (i.e. a “racetrack” or “stadium” shape), or may be a circular weld shape. Such a shape may provide for good electrical and mechanical contact between the terminal and terminal connection tab 308 and be readily repeatable by the laser welding system across plural terminal welds.

In some examples the plurality of electrical cells of a battery module may each have a first end surface 1012, wherein a first electrical terminal of each cell is located in a central region of the first end surface 1012. The plurality of terminal connection tabs 808 may be protruding from the lattice portion 802 of the busbar assembly 806 and may each be welded to the central region of the first end surface 1012 of respective electrical cells of the plurality of electrical cells. In some examples the plurality of electrical cells of a battery module may each have at least part of a second terminal located in a peripheral region 1016 of the first end surface 1012. A second plurality of terminal connection tabs 808 may be protruding from a further lattice portion 802 of the busbar assembly 806 and may each be welded to the peripheral region 1016 of the first end surface 1012 of respective electrical cells of the plurality of electrical cells 1010.

Any of the abovementioned example busbar assemblies 806 may be part of a battery module 300, and a plurality of battery modules 300 as disclosed herein may be incorporated together to form a battery pack. It may be useful to be able to combine plural battery modules 300 together to form a larger battery pack and the busbar assemblies 206 may be designed to easily work together as a composite busbar assembly over all the cells of the battery pack. In some examples there may be one busbar assembly attached across plural electrical cell arrays.

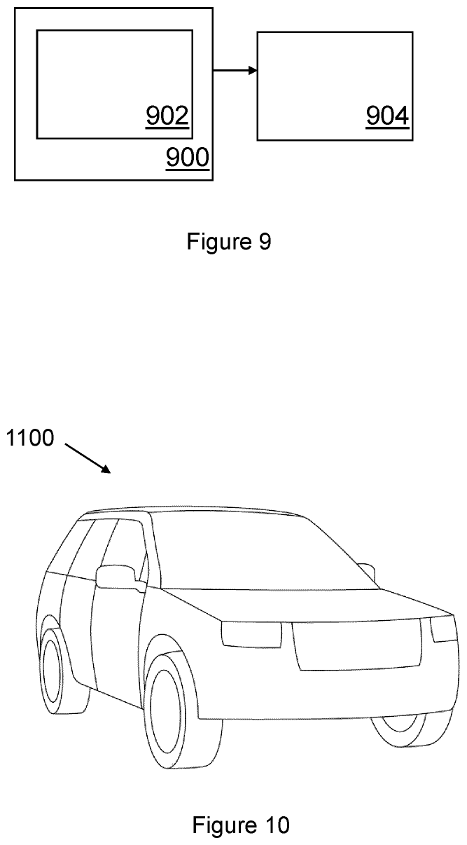

FIG. 9 shows a control system 900. The control system 900 may comprise one or more controllers 902. The control system 900 is configured to control a welding system 904 to perform a welding process to manufacture a battery module comprising a plurality of electrical cells and a busbar assembly as disclosed herein. Namely, the busbar assembly comprises a terminal collection plate and a lattice portion, and the lattice portion comprises a plurality of terminal connection tabs, and the control system 900 controls the welding system 904 to: weld the terminal collection plate to a lattice portion at a plurality of busbar welds to form the busbar assembly; and weld the plurality of terminal connection tabs to respective electrical terminals of the plurality of electrical cells, wherein each terminal connection tab is welded to its respective electrical terminal by a terminal weld, wherein a first distance is a distance along an electrical path on the lattice portion between one of the plurality of terminal welds and the closest of one of the plurality of busbar welds, and wherein the first distance for each terminal weld is substantially electrically equivalent.

The controller(s) 902 may each comprise a control unit or computational device having one or more electronic processors. A single control system 900 or electronic controller 900 may be used, or alternatively, different functions of the control system 902 may be embodied in, or hosted in, different controllers 902. A set of computer-readable instructions may be provided which, when executed, cause said controller(s) 902 or control module 900 to implement the methods described herein.

The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, or, optionally, on the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

FIG. 10 shows an example vehicle 1000, comprising any battery module 300 as disclosed herein, or any battery pack as disclosed herein.

Also encompassed in this disclosure is computer software (as an example of computer program code) that, when executed, is arranged to perform any method described herein, for example to control a laser welding system. The computer software may be stored in a micro-controller, firmware, and/or on a computer readable medium, and be therefore recorded on a non-transitory computer readable medium. That is, the computer software may be tangibly stored on a computer readable medium. It will be appreciated that examples of such computer program code may be realised in the form of hardware, software or a combination of hardware and software.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The claims are not restricted to the details of any foregoing examples. The claims cover and encompass any novel one, or any novel combination, of the features disclosed in this specification (including any accompanying claims, abstract and drawings), or to any novel one, or any novel combination, of the steps of any method or process so disclosed. The claims should not be construed to cover merely the foregoing examples, but also any examples which fall within the scope of the claims.

1. A method of laser welding a lattice portion of a busbar assembly, the lattice portion comprising copper, to a terminal collection plate of the busbar assembly, the terminal collection plate comprising aluminium,
the method comprising controlling a laser welding system to perform a welding process to weld the lattice portion and the terminal collection plate together at a plurality of weld points by:
welding the lattice portion and the terminal collection plate together at a first weld point;
welding the lattice portion and the terminal collection plate together at a second weld point; and
welding the lattice portion and the terminal collection plate together at a third point in a region formed between the first and the second weld point.

2. The method of laser welding of claim 1, wherein the first weld point and the second weld point are in a peripheral region of the busbar assembly, and the third weld point is in a central region of the busbar assembly.

3. The method of laser welding of claim 1, wherein a plurality of weld points are located between the first and second weld points.

4. The method of laser welding of claim 3, wherein the plurality of weld points located between the first and second weld points are neighbouring each other.

5. The method of laser welding of claim 1, wherein welding the plurality of terminal connection tabs to respective electrical terminals of a plurality of electrical cells comprises:
controlling the laser welding system to control a laser beam generated by the laser welding system to produce a weld path comprising a predetermined shape, wherein the laser welding system is configured to control the beam to oscillate elliptically about the weld path.

6. The method of laser welding of claim 1, wherein the first weld point is located at a first edge region of the busbar assembly, and the second weld point is located in a second edge region of the busbar assembly, opposite the first edge region.

7. The method of laser welding of claim 1, comprising:
welding the lattice portion and the terminal collection plate together at a plurality of weld points of a peripheral region of the busbar assembly; and
welding the lattice portion and the terminal collection plate together at a plurality of weld points of an inner region, within the peripheral region, of the busbar assembly.

8. The method of laser welding of claim 1, wherein the busbar assembly comprises a plurality of corners, comprising:
welding the lattice portion to the terminal collection plate together by welding the lattice portion and the terminal collection plate together at weld points located at each of the plurality of corners of the weld surface.

9. The method of laser welding of claim 8, comprising:
after welding the lattice portion and the terminal collection plate together at the weld points located at each of the plurality of corners of the weld surface,
welding the lattice portion and the terminal collection plate together at a plurality of inner weld points of an inner region of the busbar assembly.

10. The method of laser welding of claim 1, comprising welding the lattice portion and the terminal collection plate together at a plurality of weld points located along a weld path which spirals towards the centre of the busbar assembly.

11. The method of laser welding of claim 1, wherein welding the lattice portion and the terminal collection plate together at a plurality of inner weld points of an inner region of the busbar assembly comprises:
welding a plurality of weld points along a first weld point path in a first direction, the first weld point path located inside a peripheral region of the busbar assembly; and
welding at least one further plurality of weld points along at least one further weld point path in a second direction opposite the first direction, wherein the further weld point path is located within the first weld point path.

12. The method of laser welding of claim 1, wherein the busbar assembly is substantially planar.

13. The method of laser welding of claim 1, wherein the method is performed without using an external clamping member to forcibly clamp the lattice portion to the terminal collection plate during welding.

14. The method of laser welding of claim 1, wherein the first and second weld points each form clamping points acting to clamp the lattice portion to the terminal collection plate at the respective weld points.

15. The method of laser welding of claim 1, wherein:
the lattice portion and the terminal collection plate are each substantially flat in a rectangular plane, having a width of between 80 mm and 95 mm, and having a length of between 80 mm and 95 mm, and
wherein, after welding, the busbar assembly is distorted out of the flat plane of less than 0.2 mm.

16.-20. (canceled)
